(19) United States
(12) Patent Application Publication
(10) Pub. No.: US 2016/0181654 A1
(43) Pub. Date: Jun. 23, 2016

(54) SECONDARY BATTERY

(71) Applicant: Samsung SDI Co. , Ltd., Yongin-si (KR)

(72) Inventor: Kangkook Jung, Yongin-si (KR)

(21) Appl. No.: 14/973,526

(22) Filed: Dec. 17, 2015

(30) Foreign Application Priority Data
Dec. 22, 2014 (KR) 10-2014-0186361

(51) Int. Cl. H01M 10/04; H01M 2/02

(52) U.S. Cl. CPC H01M 10/0436; H01M 2/0207; H01M 2/0217; H01M 2002/0205; H01M 2220/30

(57) ABSTRACT

A secondary battery is disclosed. In one aspect, the battery includes an electrode assembly including a first electrode plate, a second electrode plate, and a separator interposed between the first and second electrode plates, wherein the electrode assembly includes first and second sides opposing each other, and third and fourth sides opposing each other and longer than the first and second sides. The battery also includes a can accommodating the electrode assembly and having a generally rectangular shape, wherein the can includes at least one side that is deformed from the rectangular shape. The battery further includes a first electrode tab and a second electrode tab placed on a selected one of the first and second sides of the electrode assembly.

### RELATED APPLICATION

This application claims the benefit of Korean Patent Application No. 10-2014-0186361, filed on Dec. 22, 2014, in the Korean Intellectual Property Office, the disclosure of which is incorporated herein in its entirety by reference.

### BACKGROUND

1. Field

The described technology generally relates to a secondary battery.

2. Description of the Related Technology

Along with the technological developments in the field of electronics, the market for various portable electronic devices, such as smartphones, smart pads, e-book readers, flexible tablet computers, portable medical devices attachable to the skin, cellular phones, game devices, portable multimedia players (PMP), MPEG audio layer-3 (MP3) players, and the like has grown considerably.

Accordingly, the need for rechargeable batteries for such devices has increased. Also, batteries of specific shapes and structures vary across devices, unique battery requirements have multiplied.

In addition, the manufacture of a small-sized battery having reduced dead space is desired for greater portability.

### SUMMARY OF CERTAIN INVENTIVE ASPECTS

One inventive aspect relates to a secondary battery.

Another aspect is a secondary battery that includes an electrode assembly including a first electrode plate, a second electrode plate, and a separator between the first electrode plate and the second electrode plate; a can that accommodates the electrode assembly and has at least one side that is deformed from a rectangular shape; and a first electrode tab and a second electrode tab that provided in a long side of the electrode assembly.

The secondary battery may further include a cap plate provided in a side surface corresponding to a long side of the can, wherein the cap plate is coupled with and seals the can.

The first electrode plate and the second electrode plate may respectively have short sides of different lengths according to a shape of the can.

At least one side surface between two side surfaces of the can may be an inclined surface.

At least one side surface between two side surfaces of the can may be a curved surface.

A length of short side of the first electrode plate and the second electrode plate may be stacked in a sequentially ascending manner to form the electrode assembly.

The can may have two side surfaces that respectively have a semicircular shape.

A length of the short side of an electrode plate stacked in the first electrode plate and the second electrode plate may be the longest.

Another aspect is a secondary battery comprising: an electrode assembly comprising a first electrode plate, a second electrode plate, and a separator interposed between the first and second electrode plates, wherein the electrode assembly includes first and second sides opposing each other, and third and fourth sides opposing each other and shorter than the first and second sides; a can accommodating the electrode assembly and having a generally rectangular shape, wherein the can includes first and second sides opposing each other, and third and fourth sides opposing each other and shorter than the first and second sides thereof, and wherein at least one of the first and second sides of the can is deformed from the rectangular shape; and a first electrode tab and a second electrode tab placed on a selected one of the first and second sides of the electrode assembly.

The above battery further comprises a cap plate placed on the selected side of the electrode assembly, wherein the cap plate is coupled with and seals the can. In the above battery, the first and second electrode plates have different lengths. In the above battery, the can includes first and second main surfaces opposing each other and surrounded by the first through fourth sides thereof, and wherein the area of each of the first and second main surfaces is greater than that of each of the first through fourth sides of the can. In the above battery, at least one of the first and second sides of the can is inclined with respect to the first and second main surfaces. In the above battery, the at least one inclined side is inclined toward one of the first and second main surfaces.

In the above battery, only one of the first and second sides of the can is inclined with respect to the first and second main surfaces. In the above battery, at least one of the first and second sides of the can is curved. In the above battery, at least one curved side is curved toward one of the first and second main surfaces. In the above battery, only one of the first and second sides is curved toward the first and second main surfaces. In the above battery, the first and second electrode plates have different lengths. In the above battery, at least one of the first and second sides of the can has a semicircular shape. In the above battery, the first and second electrode tabs have different lengths.

Another aspect is a secondary battery comprising: an electrode assembly comprising a first electrode plate, a second electrode plate, and a separator interposed between the first and second electrode plates, wherein a cross section of the electrode assembly has a substantially rectangular shape that includes a pair of long sides and a pair of short sides shorter than the long sides; a can accommodating the electrode assembly, wherein a cross section of the can has a substantially rectangular shape that includes a pair of long sides and a pair of short sides shorter than the long sides, wherein the long and short sides of the can respectively face the long and short sides of the electrode assembly, and wherein at least one of the long sides is deformed from the rectangular shape; and a first electrode tab and a second electrode tab placed on a selected one of the long sides of the electrode assembly.

In the above battery, the can includes first and second main surfaces opposing each other and surrounded by the long and short sides thereof, and wherein at least one of the long sides of the can is non-linear. In the above battery, the at least one non-linear side is toward one of the first and second main surfaces. In the above battery, the first and second electrode plates have different lengths. In the above battery, the first and second electrode tabs have different lengths.

Another aspect is a secondary battery comprising: an electrode assembly including a pair of long sides and a pair of short sides shorter than the long sides; a can accommodating the electrode assembly and including a pair of long sides and a pair of short sides shorter than the long sides, wherein the long and short sides of the can respectively face the long and short sides of the electrode assembly, wherein the can includes first and second main surfaces opposing each other and surrounded by the long and short sides thereof, and wherein at least one of the long sides of the can is non-linear; and a first electrode tab and a second electrode tab placed on at least one of the long sides of the electrode assembly.

In the above battery, the first and second electrode tabs have different lengths.

### BRIEF DESCRIPTION OF THE DRAWINGS

FIG. 1 is a perspective view schematically illustrating a secondary battery according to an embodiment.

FIG. 2 is a cross-sectional view schematically illustrating a cross-section of the secondary battery of FIG. 1.

FIG. 3 is a perspective view schematically illustrating a secondary battery according to another embodiment.

FIG. 4 is a cross-sectional view schematically illustrating a cross-section of the secondary battery of FIG. 3.

FIG. 5A is a perspective view schematically illustrating a secondary battery according to another embodiment.

FIG. 5B is a cross-sectional view schematically illustrating a cross-section of the secondary battery of FIG. 5A.

FIG. 6A is a perspective view schematically illustrating a secondary battery according to another embodiment.

FIG. 6B is a cross-sectional view schematically illustrating a cross-section of the secondary battery of FIG. 6A.

### DETAILED DESCRIPTION OF CERTAIN INVENTIVE EMBODIMENTS

Reference will now be made in detail to embodiments, examples of which are illustrated in the accompanying drawings, wherein like reference numerals refer to like elements throughout in this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

As the described technology allows for various changes and numerous embodiments, particular embodiments will be illustrated in the drawings and described in detail in the written description. However, this is not intended to limit the described technology to particular modes of practice, and it is to be appreciated that all changes, equivalents, and substitutes that do not depart from the spirit and technical scope are encompassed in the described technology.

While such terms as “first,” “second,” etc., may be used to describe various components, such components must not be limited to the above terms. The above terms are used only to distinguish one component from another.

The terms used in the present specification are :merely used to describe particular embodiments, and are not intended to limit the inventive concept. An expression used in the singular encompasses the expression of the plural, unless it has a clearly different meaning in the context. In the present specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. In this disclosure, the term “substantially” includes the meanings of completely, almost completely or to any significant degree under some applications and in accordance with those skilled in the art. Moreover, “formed on” can also mean “formed over.” The term “connected” includes an electrical connection.

Hereinafter, embodiments will be described in detail with reference to the attached drawings.

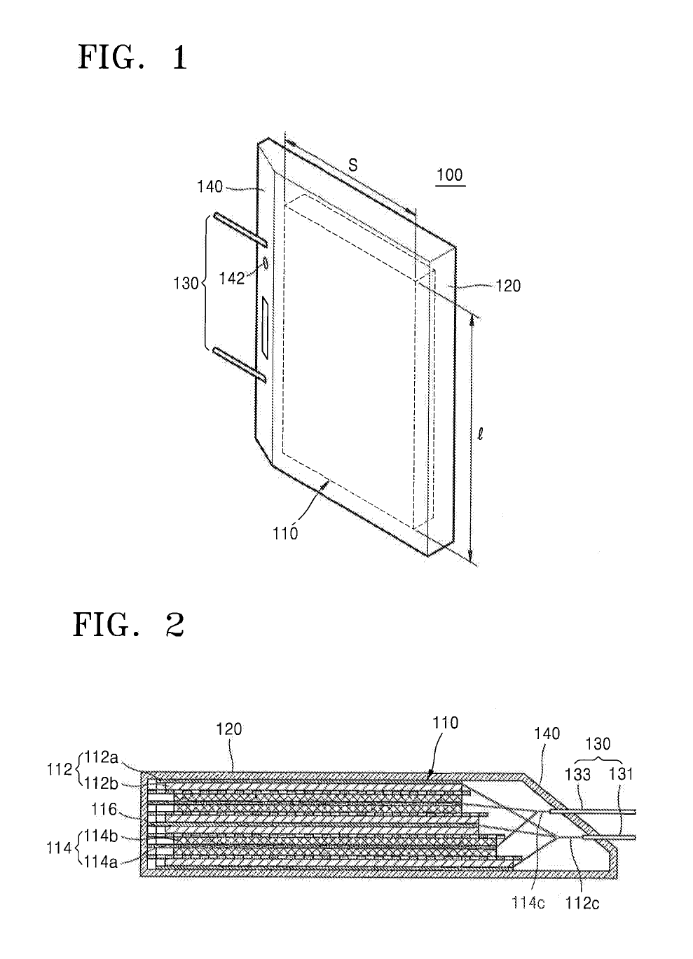

FIG. 1 is a perspective view schematically illustrating a secondary battery 100 according to an exemplary embodiment, and FIG. 2 is a cross-sectional view schematically illustrating a cross-section of the secondary battery 100 of FIG. 1,

Referring to FIGS. 1 and 2, the secondary battery 100 includes an electrode assembly 110, a can 120 that accommodates the electrode assembly 110, and an electrode tab 130 provided in a long side of the electrode assembly 110.

The electrode assembly 110 may include a first electrode plate 112, a second electrode plate 114, and a separator 116 between the first electrode plate 112 and the second electrode plate 114. For example, the electrode assembly 110 has a structure including a plurality of the first electrode plates 112, the separators 116, and the second electrode plates 114 that are repeatedly stacked therein. In FIG. 1, the left and right sides of the electrode assembly 110 may be referred to as first and second sides of the electrode assembly 110. The top and bottom sides of the electrode assembly 110 may be referred to as third and fourth sides of the electrode assembly 110. Similarly, the left and right sides of the can 120 may be referred to as first and second sides of the can 120. The top and bottom sides of the can 120 may be referred to as third and fourth sides of the can 120.

The first electrode plate 112 may be one of a positive electrode film or a negative electrode film. When the first electrode plate 112 is a positive electrode film, the second electrode plate 114 may be a negative electrode film, and, on the contrast, when the first electrode plate 112 is a negative electrode film, the second electrode plate 114 may be a positive electrode film.

The first electrode plate 112 may include a first metal current collector 112a; and a first active material portion 112b and a first uncoated area 112c on a surface of the first metal current collector 112a, where the first active material portion 112b is coated with a first active material, and the first uncoated area 112c is not coated with the first active material. In the same manner, the second electrode plate 114 may include a second metal current collector 114a and a second active material portion 114b and a second uncoated area 114c on a surface of the second metal current collector 114a, where the second active material portion 114b is coated with a second active material, and the second uncoated area 114c is not coated with the second active material.

When the first electrode plate 112 is a positive electrode film, the first metal current collector 112a may be a positive electrode current collector, and the first active material portion 112b may be a positive electrode active material portion. Also, when the second electrode plate 114 is a negative electrode film, the second metal current collector 114a may be a negative electrode current collector, and the second active material portion 114b may be a negative electrode active material portion.

The positive electrode current collector may be a metal formed of aluminum, stainless steel, titanium, silver, or a combination of materials selected therefrom. The positive electrode active material portion may include a positive electrode active material, a binder, and a conducting agent.

The positive electrode active material may be formed of a material capable of reversibly intercalating and deintercalating lithium ions. For example, the positive electrode active material may include at least one material selected from the group consisting of lithium transition metal oxides such as lithium cobalt oxide, lithium nickel oxide, lithium nickel cobalt oxide, lithium nickel cobalt aluminum oxide, lithium nickel cobalt manganese oxide, lithium manganese oxide, and lithium iron phosphate; nickel sulfide; copper sulfide; sulfur; iron oxide; and vanadium oxide.

The binder may include at least one material selected from the group consisting of a polyvinylidenefluoride-based binder such as polyvinylidenefluoride, a vinylidene fluoridethexafluoropropylene co-polymer, and a vinylidenefluoride/tetrafluoroethylene co-polymer; a carboxymethylcellulose-based binder such as sodium-carboxymethylcellulose and lithium-carboxymethylcellulose; an acrylate-based binder such as polyacrylate, lithium-polyacrylate, acryl, polyacrylonitryl, polymethylmethacrylate, and polybutylacrylate; polyamideimide; polytetrafluoroethylene; polyethylene oxide; polypyrole; lithium-nafion; and styrene-butadiene rubber-based polymer.

The conducting agent may include at least one material selected from the group consisting of a carbon-based conducting agent such as carbon black, carbon fibers, and graphite; conductive fiber such as metal fiber; a metal powder such as a carbon fluoride powder, an aluminum powder, or a nickel powder; a conductive whisker such as zinc oxide and potassium titaniunate; a conductive metal oxide such as a titanium oxide; and a conductive polymer such as a polyphenylene derivative.

The negative electrode current collector may include at least one metal selected from the group consisting of copper, stainless steel, nickel, and titanium. The negative electrode active material portion may include a negative electrode active material, a binder, and a conducting agent.

The negative electrode active material may comprise a material that can be alloyed with lithium or a material capable of reversibly intercalating and deintercalating lithium. For example, the negative electrode active material may include at least one material selected from the group consisting of a metal, a carbon-based material, a metal oxide, and a lithium metal nitride.

The metal may include at least one material selected from the group consisting of lithium, silicon, magnesium, calcium, aluminum, germanium, tin, lead, arsenic, antimony, bismuth, silver, gold, zinc, cadmium, mercury, copper, iron, nickel, cobalt, and indium.

The carbon-based material may include at least one material selected from the group consisting of graphite, graphite carbon fibers, cokes, mesocarbon microbeads (MCMB), polyacene, pitch-based carbon fibers, and non-graphitizable carbon (hard carbon).

The metal oxide may include at least one selected from the group consisting of lithium titanium oxide, titanium oxide, molybdenum oxide, niobium oxide, iron oxide, tungsten oxide, tin oxide, amorphous tin composite oxide, silicon monoxide, cobalt oxide, and nickel oxide.

The binder and the conducting agent in the negative electrode active material portion may be each respectively the same with the binder and the conducting agent included in the positive electrode active material portion.

The separator 116 may be a porous polymer layer formed by including at least one of polyethylene (PE), polystyrene (PS), and polypropylene (PP). For example, the separator 116 may be prepared by coating a substrate formed of at least one selected from the group consisting of polyethylene (PE), polystyrene (PS), polypropylene (PP), a co-polymer of polyethylene (PE) and polypropylene (PP), and a polyvinylidenefluoride-hexafluoropropylene co-polymer (PVDF-HFP co-polymer), but embodiments are not limited thereto. The separator 116 may be formed with an area larger than areas of the first electrode plate 112 and the second electrode plate 114 to prevent short-cut between the first electrode plate 112 and the second electrode plate 114.

The electrode tab includes a first electrode tab 131 and a second electrode tab 133. The first and second electrode tabs 131 and 133 are attached to the electrode assembly 110. The first electrode tab 131 and the second electrode tab 133 may be respectively attached to each of a plurality of the first uncoated areas 112c and the second uncoated areas 114c that form a stack structure manufactured by, for example, welding.

The first electrode tab 131 may be electrically connected to the first electrode plate 112. One end of the first electrode tab 131 may be attached to the first uncoated area 112c by, for example, welding, and the other end of the first electrode tab 131 may be also attached to a cap plate 140 by, for example, welding.

The second electrode plate 114 may be electrically connected to the second electrode tab 133. One end of the second electrode tab 133 may be attached to the second uncoated area 114c by, for example, welding, and the other end of the second electrode tab 133 may be attached to an electrode terminal 142 by, for example, welding.

As shown in FIGS. 1 and 2, the secondary battery 100 includes the first electrode tab 131 and the second electrode tab 132 located in a long side (l) among a long side (l) and a short side (s) of the electrode assembly 110.

In general, a first electrode tab and a second electrode tab are located in a short side of an electrode assembly.

However, the secondary battery 100 according to an embodiment may include the first and second electrode tabs 131 and 133 in the long side l of the electrode assembly 110 in order to prevent double generation of a dead-space due to various shapes of the can 120 accommodating the electrode assembly 110.

A shape of the can 120 and the accompanying location of the electrode tab 130 will be described in detail along with the description of the shape of the can 120.

As shown in FIGS. 1 and 2, the secondary battery 100 includes the can 120 that accommodates the electrode assembly 110 and has at least one portion with a certain shape.

The can 120 may include an opening (not shown) in one side so that the electrode assembly 110 may be inserted through the opening, and once the electrode assembly 110 is accommodated in the can 120, the opening of the can 120 may be sealed by the cap plate 140.

The shape of the cap plate 140 may be determined by the shape of the can 120 so that the cap plate 140 may be coupled with the can 120 to seal the electrode assembly 110. That is, when the can 120 has at least one portion with a certain shape as described above, the cap plate 140 may also have at least one portion with a certain shape.

Here, referring to FIG. 1, the opening and the cap plate 140 may be located in a long side among long and short sides of the can 120. That is, the opening is positioned in a long side of the can 120, and the cap plate 140 may be prepared to seal the opening. The cap plate 140 has a predetermined vertical length and seals the can 120 from a side thereof.

Unlike a conventional secondary battery which generally has a can in a rectangular shape, the secondary battery 100 according to an embodiment may include at least one side among two sides of the can 120 in a different shape as shown in FIG. 1.

As a secondary battery is used in various types of electronic devices, a need for various shapes of the secondary battery has increased. Accordingly, unlike a typical secondary battery which generally has a rectangular hexahedron shape, a shape of a secondary battery needs to vary depending on conditions.

In this regard, FIG. 1 illustrates a secondary battery having one side of the can 120 that is an inclined surface as one type of the secondary battery 100 according to an embodiment. However, this is only one type of a secondary battery according to an embodiment, and the described technology is not limited thereto, so the secondary battery may be implemented in various other types.

Referring to FIGS. 1 and 2, the secondary battery 100 has at least one side wall with a certain shape of two side walls of the can 120 is inclined by a predetermined angle. Accordingly, usability of the secondary battery may increase.

Recently, usability of a secondary battery in various electronic devices has increased, and as types of the electronic devices varies, a shape of the secondary battery used as a power source of an electronic device consequentially needs to change variously in accordance with the types of electronic devices as well.

For example, in the case of a cell phone, which is a portable electronic device, its design has varied. When a cell phone is curved or flexible, a secondary battery included in the cell phone may be a curved or flexible battery, or the secondary battery according to an embodiment having one inclined side wall may be required.

Thus, usability of the secondary battery may increase as at least one side wall of the secondary battery is formed as an inclined plane at a predetermined angle.

When at least one side wall of the secondary battery is inclined at a predetermined angle, the secondary battery may double generate a dead-space. That is, as the at least one side wall is inclined, when the electrode assembly 110 is accommodated in the secondary battery 100 having a rectangular shape, a dead-space may be formed under the at least one side wall. Also, when an electrode tab is attached to a top surface of the electrode assembly 110, a dead-space may be formed between the cap plate 140 and the electrode assembly 110.

To prevent the double-generation of the dead-space, the secondary batter 100 may include the electrode tab 130 in the dead-space that is generated because the one side wall of the can 120 is inclined.

The first and second electrode tabs 131 and 133 may be formed in the long side of a side wall portion of the electrode assembly 110 as described above, and the cap plate 140 attached with the first electrode tab 131 and the electrode terminal 142 attached with the second electrode tab 133 attached thereto may all be situated on the inclined side wall of the can 120.

The secondary battery 100 may be manufactured to have various shapes, and thus, a dead-space that may be generated due to the shape of the secondary battery, may be used to provide the electrode tab 130 thereon.

Referring to FIG. 2, a length of the short side of the electrode assembly 130 accommodated inside the can 120 may change according to a shape of the can 120. For example, when one side wall of the can 120 is formed as an inclined plane, a short side of a front wall and a short side of a back wall may be different from each other.

Accordingly, a length of the short side (s) of the electrode assembly 110 may also ascend toward the short side of the can 120 with a relatively long length from the short side of the can 120 with a relatively short length. Thus, the dead-space which may be generated due to the shape of the can 120 may be minimized.

Also, when the first and second electrode tabs 131 and 133 attached on the electrode assembly 110 are positioned at the long side (l) of the electrode assembly 110, a dead space may be utilized without preparing a separate space as described above.

The can 120 can be formed of a conductive material such as aluminum to protect the electrode assembly 110 from external impact and to serve as a heat insulating board that dissipates heat involved in the charge and discharge operation of the electrode assembly 110 to the outside.

The cap plate 140 may be formed of the same material used in formation of the can 120, and may couple with the can 120 by welding to seal the opening (not shown). An electrolyte inlet (not shown) may be formed in one side of the cap plate 140. Once the cap plate 140 couples with the can 120, an electrolyte may be injected into the can 120 through the electrolyte inlet, and the electrolyte inlet may be sealed with a stopper (not shown).

As the can 120 may have various shapes, the cap plate 140 may also be formed to couple with the can 120 of various shapes. That is, a shape of the cap plate 140 is the same with that of the can 120, and thus when the cap plate 140 couples with the can 120 at the long side of the can 120, the electrode assembly 110 may be sealed.

The first electrode tab 131 may be attached to the cap plate 140 by, for example, welding. Also, the electrode terminal 142 connected to the second electrode tab 133 is formed on the cap plate 140, and an insulator (not shown) may be disposed between the electrode terminal 142 and the cap plate 140 to prevent short-circuit between the electrode terminal 142 and the cap plate 140.

The can 120 is electrically connected to the cap plate 140, and the cap plate 140 is electrically connected to the first electrode tab 131, and thus the can 120 may have the same polarity with the first electrode plate 112.

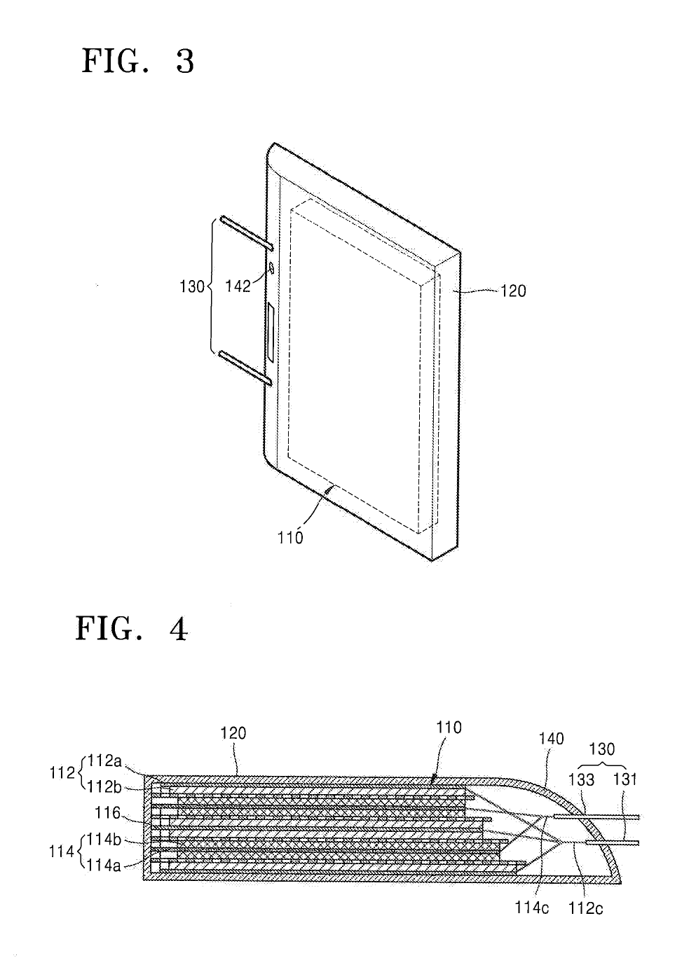

FIG. 3 is a perspective view schematically illustrating a secondary battery according to another embodiment. FIG. 4 is a cross-sectional view schematically illustrating a cross-section of the secondary battery of FIG. 3. In FIGS. 3 and 4, the same reference numerals as in FIGS. 1 and 2, denote the same elements and descriptions thereof are not repeated.

Referring to FIG. 3, the secondary battery may have at least one of two side walls of a can 120 formed in a curved shape. As a shape of the can 120 varies, a secondary battery with various shapes may be used according to the need.

As described above, a cap plate 140 may be deformed to suit a shape of the can 120 when a shape of the can 120 is changed. As shown in FIG. 3, one of the two side walls of the can 120 and the cap plate 140 has a curved surface.

The secondary battery according to the current embodiment includes an electrode tab 130 provided in a long side of an electrode assembly 110 in the same manner as described in connection with the secondary battery 100 of the previous embodiment, and thus a dead-space generated due to the curved surface of the one side wall of the can 120 may be utilized as an advantageous effect.

Also, the cap plate 140 is included in the long side of the can 120, and thus, as shown in FIG. 3, an electrolyte inlet 156 for injecting an electrolyte, a stopper 160, and an electrode terminal 142 may also positioned in the long side of the can 120 to seal the can 120.

Referring to FIG. 4, as one side wall of the can 120 is formed as a curved surface, it may be known that a short side of a front surface of the can 120 and a short side of a back surface of the can 120 are different from each other. Accordingly, lengths of short sides of the electrode assemblies 110 accommodated in the can 120 may vary.

A short side of the electrode assembly 110 located near the short side of the can 120 with a comparably short length may be relatively short, and a short side of the electrode assembly 110 located near the short side of the can 120 with a comparably long length may be relatively long.

Also, a plurality of the electrode assemblies 110 may be stacked in the ascending order of lengths of the short sides (s) of the electrode assemblies 110.

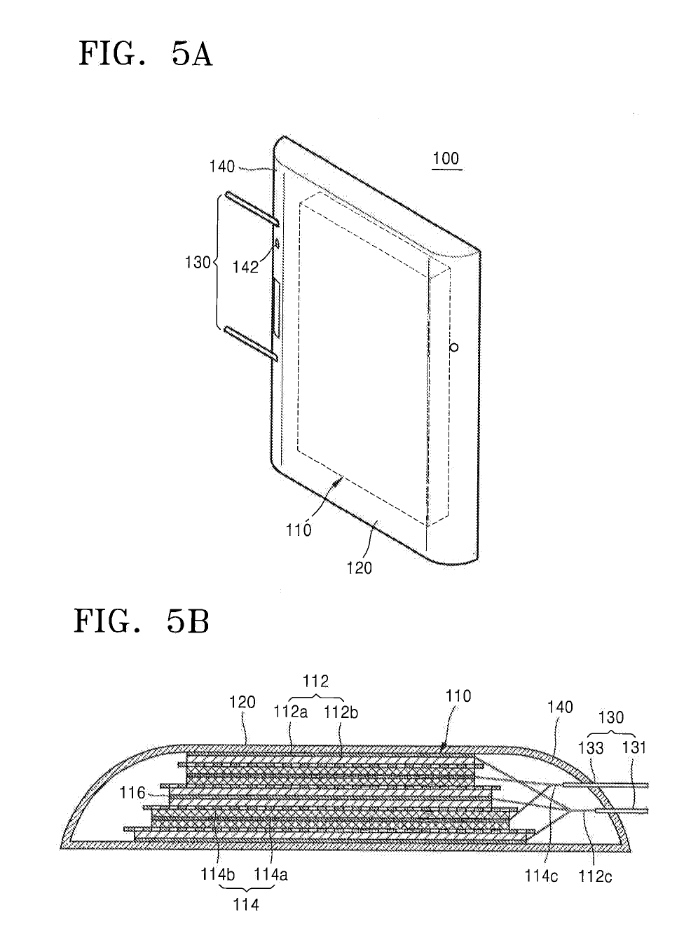

FIG. 5A is a perspective view schematically illustrating a secondary battery according to another embodiment. FIG. 5B is a cross-sectional view schematically illustrating a cross-section of the secondary battery of FIG. 5A. In FIGS. 5A and 5B, the same reference numerals as those in FIGS. 1 to 4 denote the same elements and thus the descriptions thereof are not repeated.

Referring to FIG. 5A, both side walls of the can 120 may have a curved surface. As a shape of the can 120 varies, a secondary battery with various shapes may be used according to the need.

As described above, a cap plate 140 may be deformed to suit a shape of the can 120 when the shape of the can 120 is changed. As shown in FIG. 5A, the two side walls of the can 120 and the cap plate 140 may have a curved surface.

Referring to FIG. 5B, the secondary battery includes an electrode tab 130 provided in a long side of an electrode assembly 110 in the same manner as described in connection, with the secondary battery 100 of the previous embodiment, and thus a dead-space generated due to the curved surface of a one side wall of the can 120 may be utilized as an advantageous effect.

Referring to FIG. 5B, as both side walls of the can 120 are formed as a curved surface, lengths of short sides (s) of the electrode assemblies 110 accommodated in the can 120 may vary. Since the two side walls of the can 120 are formed as a curved surface, a length of a short side among a front wall and a back wall of the can 120 may be relatively short, and the other side may be relatively long.

Therefore, the electrode assemblies 110 may also have different lengths of the short sides (s) to suit a shape of the can 120. The length of the short side of the electrode assembly 110 located near the short side of the can 120 may be with a comparably short length may be relatively short, and a length of the short side of the electrode assembly 110 located near the short side of the can 120 with a comparably long length may be relatively long.

Also, a plurality of the electrode assemblies 110 may be stacked in a sequentially ascending manner of the lengths of the short sides (s) of the electrode assemblies 110.

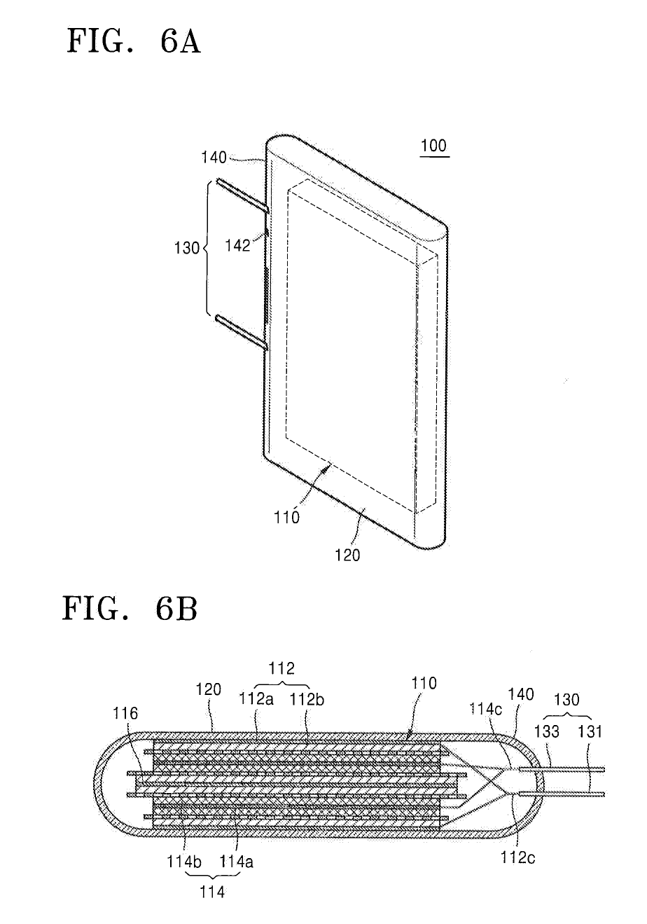

FIG. 6A is a perspective view schematically illustrating a secondary battery according to another embodiment. FIG. 6B is a cross-sectional view schematically illustrating a cross-section of the secondary battery of FIG. 6A. In FIGS. 6A and 6B, the same reference numerals as in FIGS. 1 to 4 denote the same elements, and thus, descriptions thereof are not repeated.

Referring to FIG. 6A, both side walls of the can 120 may have a semi-circular shape. When a shape of the can 120 varies, various types of secondary batteries may be used according to the need.

As described above, when the shape of the can 120 varies, the shape of the cap plate 140 may as well change to suit the shape of the can 120, and as shown in FIG. 6A, both side walls of the can 120 and the cap plate 140 may all be formed in a semi-circular shape.

Referring to FIG. 6B, the secondary battery also includes the electrode tab 130 located in a long side of the electrode assembly 110, and thus a dead-space generated according to the change of a shape of the can 120 may be utilized.

As shown in FIG. 6B, when both side walls of the can 120 is formed in a semi-circular shape, lengths of the short sides (s) of the electrode assemblies 110 accommodated inside the can 120 may vary. That is, the electrode assembly 110 accommodated inside the can 120 may have different lengths of the short side to suit a shape of the can 120.

Referring to FIG. 6B, the can 120 has a side wall portion concave toward the outside thereof, and the electrode assembly 110 accommodated inside the can 120 may include an electrode plate with a short side higher than the short sides of the electrode plates stacked toward both front and back walls. Lengths of the short sides of the electrode plates decrease toward the front and back walls.

As described above, according to at least, one of the disclosed embodiments, the shape of a secondary battery may vary, and a dead-space of the battery may be utilized at the same time.

It should be understood that the exemplary embodiments described therein should be considered in a descriptive sense only and not for purposes of limitation. Descriptions of features or aspects within each embodiment should typically be considered as available for other similar features or aspects in other embodiments.

While the inventive technology has been described with reference to the figures, it will be understood by those of ordinary skill in the art that various changes in form and details may be made therein without departing from the spirit and scope of the present invention as defined by the following claims.

What is claimed is:

1. A secondary battery comprising:
an electrode assembly comprising a first electrode plate, a second electrode plate, and a separator interposed between the first and second electrode plates, wherein the electrode assembly includes first and second sides opposing each other, and third and fourth sides opposing each other and shorter than the first and second sides;
a can accommodating the electrode assembly and having a generally rectangular shape, wherein the can includes first and second sides opposing each other, and third and fourth sides opposing each other and shorter than the first and second sides thereof, and wherein at least one of the first and second sides of the can is deformed from the rectangular shape; and
a first electrode tab and a second electrode tab placed on a selected one of the first and second sides of the electrode assembly.

2. The secondary battery of claim 1, further comprising a cap plate placed on the selected side of the electrode assembly, wherein the cap plate is coupled with and seals the can.

3. The secondary battery of claim 1, wherein the first and second electrode plates have different lengths.

4. The secondary battery of claim 1, wherein the can includes first and second main surfaces opposing each other and surrounded by the first through fourth sides thereof, and wherein the area of each of the first and second main surfaces is greater than that of each of the first through fourth sides of the can.

5. The secondary battery of claim 4, wherein at least one of the first and second sides of the can is inclined with respect to the first and second main surfaces.

6. The secondary battery of claim 5, wherein the at least one inclined side is inclined toward one of the first and second main surfaces.

7. The secondary battery of claim 4, wherein only one of the first and second sides of the can is inclined with respect to the first and second main surfaces.

8. The secondary battery of claim 4, wherein at least one of the first and second sides of the can is curved.

9. The secondary battery of claim 8, wherein the at least one curved side is curved toward one of the first and second main surfaces.

10. The secondary battery of claim 8, wherein only one of the first and second sides is curved toward the first and second main surfaces.

11. The secondary battery of claim 1, wherein the first and second electrode plates have different lengths.

12. The secondary battery of claim 1, wherein at least one of the first and second sides of the can has a semicircular shape.

13. The secondary battery of claim 1, wherein the first and second electrode tabs have different lengths.

14. A secondary battery comprising:
an electrode assembly comprising a first electrode plate, a second electrode plate, and a separator interposed between the first and second electrode plates, wherein a cross section of the electrode assembly has a substantially rectangular shape that includes a pair of long sides and a pair of short sides shorter than the long sides;
a can accommodating the electrode assembly, wherein a cross section of the can has a substantially rectangular shape that includes a pair of long sides and a pair of short sides shorter than the long sides, wherein the long and short sides of the can respectively face the long and short sides of the electrode assembly, and wherein at least one of the long sides is deformed from the rectangular shape; and
a first electrode tab and a second electrode tab placed on a selected one of the long sides of the electrode assembly.

15. The secondary battery of claim 14, wherein the can includes first and second main surfaces opposing each other and surrounded by the long and short sides thereof, and wherein at least one of the long sides of the can is non-linear.

16. The secondary battery of claim 15, wherein the at least one non-linear side is curved toward one of the first and second main surfaces.

17. The secondary battery of claim 14, wherein the first and second electrode plates have different lengths.

18. The secondary battery of claim 14, wherein the first and second electrode tabs have different lengths.

19. A secondary battery comprising:
an electrode assembly including a pair of long sides and a pair of short sides shorter than the long sides;
a can accommodating the electrode assembly and including a pair of long sides and a pair of short sides shorter than the long sides, wherein the long and short sides of the can respectively face the long and short sides of the electrode assembly, wherein the can includes first and second main surfaces opposing each other and surrounded by the long and short sides thereof, and wherein at least one of the long sides of the can is non-linear; and
a first electrode tab and a second electrode tab placed on at least one of the long sides of the electrode assembly.

20. The secondary battery of claim 19, wherein the first and second electrode tabs have different lengths.
